(19) United States
(12) Patent Application Publication
(10) Pub. No.: US 2023/0118981 A1
(43) Pub. Date: Apr. 20, 2023

(54) General purpose functionality processor with a scalable architecture for neural networks

(71) Applicant: Roviero, Inc., San Jose, CA (US)

(72) Inventors: Deepak Mital, Livermore, CA (US); Ravi Sreenivasa Setty, Fremont, CA (US); Vlad Ionut Ursachi, Santa Clara, CA (US); Venkateswarlu Bandaaru, San Jose, CA (US); Xiaochun Li, San Ramon, CA (US); Tianran Chen, San Jose, CA (US)

(73) Assignee: Roviero, Inc., San Jose, CA (US)

(21) Appl. No.: 17/968,544

(22) Filed: Oct. 18, 2022

Related U.S. Application Data
(60) Provisional application No. 63/341,766, filed on May 13, 2022.
(60) Provisional application No. 63/256,902, filed on Oct. 18, 2021.
(60) Provisional application No. 63/256,908, filed on Oct. 18, 2021.

(51) Int. Cl. G06N 3/04

(52) U.S. Cl. CPC G06N 3/04

(57) ABSTRACT

An integrated circuit with a neural network can reduce the number of accesses off circuit by embedding a dedicated processor for each cluster in a neural network. The integrated circuit has a neural network of multiple arithmetic logic units arranged in clusters. Each arithmetic logic unit have one or more computing engines and a local arithmetic memory. The integrated circuit can associate a scheduler with each cluster. The integrated circuit can associate a cluster local memory with each cluster. The integrated circuit can associate a dedicated embedded processor with each cluster. The dedicated embedded processor is capable of performing general purpose operations. The integrated circuit can execute a non-computational operation offloaded from the cluster.

### RELATED APPLICATION

This application claims priority to and the benefit of under 35 USC 119 of U.S. provisional patent application titled “A method and apparatus having a scalable architecture for neural networks,” filed Oct. 18, 2021, Ser. No. 63/256,908, as well as priority to and the benefit of under 35 USC 119 of U.S. provisional patent application titled “A method and apparatus having a memory manager for neural networks,” filed Oct. 18, 2021, Ser. No. 63/256,902, as well as priority to and the benefit of under 35 USC 119 of U.S. provisional patent application titled “A general purpose functionality processor with a scalable architecture for neural networks” filed May 13, 2022, Ser. No. 63/341,766, which are incorporated herein by reference in their entirety.

### NOTICE OF COPYRIGHT

A portion of this disclosure contains material that is subject to copyright protection. The copyright owner has no objection to the facsimile reproduction by anyone of the material subject to copyright protection as it appears in the United States Patent & Trademark Office's patent file or records, but otherwise reserves all copyright rights whatsoever.

### FIELD

Embodiments generally relate to an apparatus and a method having a scalable architecture for neural networks.

### BACKGROUND

An artificial neural network mimics biological neural processes to process large sets of data. A node, or artificial neuron, receives an input signal, which the node then processes to produce an output signal to pass via an edge to one or more subsequent nodes in a chain. The neuron can apply a weight to the output signal to increase or decrease the strength of the signal based on learned behavior. The neurons can be grouped into layers based upon the type of transformation the neuron is applying. An input layer can receive a signal, pass that signal through multiple transformation layers, before producing a transformed signal at an output layer. A convolutional neural network is frequently used in the field of image processing.

### SUMMARY

Provided herein are some embodiments. In an embodiment, the design is directed to an apparatus and a method to efficiently do computation for neural networks.

These and other features of the design provided herein can be better understood with reference to the drawings, description, and claims, all of which form the disclosure of this patent application.

An integrated circuit with an AI processor for a neural network can reduce the number of accesses off circuit by embedding and integrating a dedicated processor for each cluster on the integrated circuit. The integrated circuit has multiple arithmetic logic units arranged in clusters. Each arithmetic logic unit have one or more computing engines and a local arithmetic memory. The integrated circuit can associate a scheduler with each cluster. The integrated circuit can associate a cluster local memory with each cluster. The integrated circuit can associate a dedicated embedded processor with each cluster. The dedicated embedded processor is capable of performing general purpose operations. The integrated circuit can execute a non-computational operation offloaded from the cluster.

### BRIEF DESCRIPTION OF THE DRAWINGS

The multiple drawings refer to the example embodiments of the design. In addition, various documents are submitted with this application that also form part of the entire patent application.

FIG. 1 illustrates, in a block diagram, one embodiment of an artificial intelligence processor used with an AI system such as a neural network.

FIG. 2 illustrates, in a block diagram, one embodiment of a detailed view of an arithmetic logic unit.

FIG. 3 illustrates, in a block diagram, one embodiment of a neural network with dedicated embedded processors for the clusters.

FIG. 4 illustrates, in a block diagram, one embodiment of a library of a default set of general-purposes functionalities.

FIG. 5 illustrates, in a block diagram, one embodiment of an offload data structure.

FIG. 6 illustrates, in a flowchart, one embodiment of a method for processing a data set with an artificial intelligence processor using embedded processors.

FIG. 7 illustrates, in a flowchart, one embodiment of a method for offloading a general-purpose operation to a dedicated embedded processor.

FIG. 8 illustrates, in a flowchart, one embodiment of a method for electronic design automation.

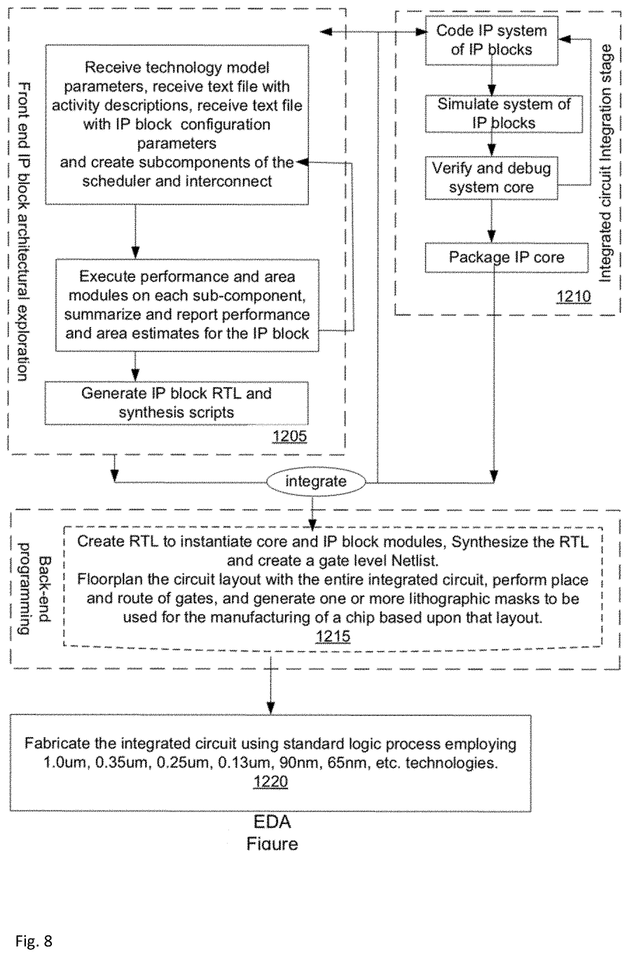

FIG. 9 illustrates, in a block diagram, one embodiment of a computing system.

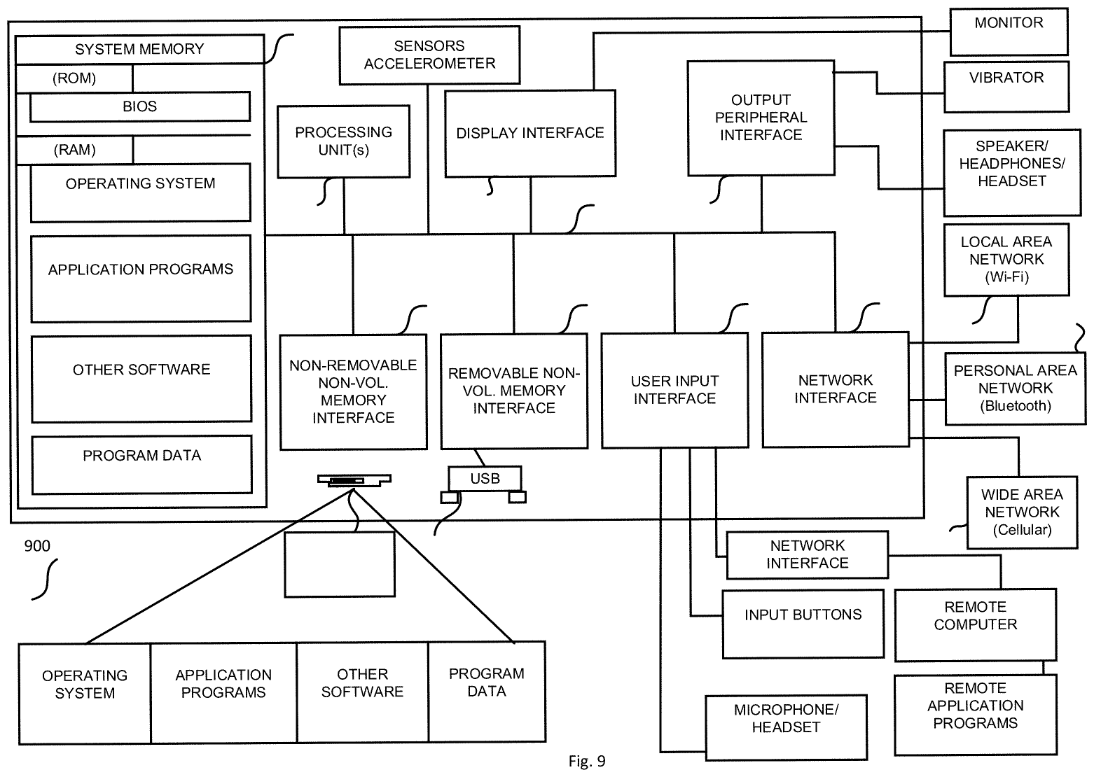

While the design is subject to various modifications and alternative forms, specific embodiments thereof have been shown by way of example in the drawings and will herein be described in detail. The design should be understood to not be limited to the particular forms disclosed, but on the contrary, the intention is to cover all modifications, equivalents, and alternatives falling within the spirit and scope of the design.

### DETAILED DISCUSSION

In the following description, numerous specific details are set forth, such as examples of specific data signals, named components, number of wheels in a device, etc., in order to provide a thorough understanding of the present design. It will be apparent, however, to one of ordinary skill in the art that the present design can be practiced without these specific details. In other instances, well known components or methods have not been described in detail but rather in a block diagram in order to avoid unnecessarily obscuring the present design. Further, specific numeric references such as a first computing engine, can be made. However, the specific numeric reference should not be interpreted as a literal sequential order but rather interpreted that the first computing engine is different than a second computing engine. Thus, the specific details set forth are merely exemplary. Also, the features implemented in one embodiment may be implemented in another embodiment where logically possible. The specific details can be varied from and still be contemplated to be within the spirit and scope of the present design. The term coupled is defined as meaning connected either directly to the component or indirectly to the component through another component.

The apparatus and method can efficiently do computations for neural networks as well as have a scalable architecture to adapt to most Artificial Intelligence (AI) networks, as well as optimize memory accesses and allocation and some example features will be discussed below. The AI processor is tailored to support Artificial Intelligence including neural networks. The AI processor can be fabricated in an integrated circuit. The integrated circuit efficiently processes and executes Artificial Intelligence operations. The integrated circuit has adapted components to process and execute Artificial Intelligence operations, including computations for a neural network having weights with a sparse value. The integrated circuit contains a scheduler, one or more arithmetic logic units (ALUs), a communication bus, a mode controller, and one or more random access memories configured to cooperate with each other to process and execute these computations for the neural network.

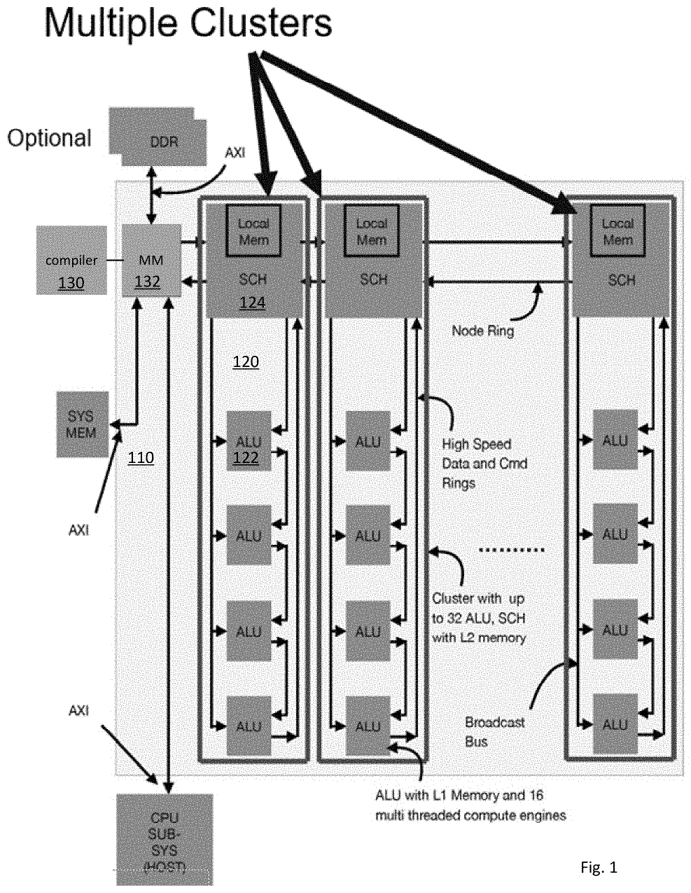

FIG. 1 illustrates, in a block diagram, an embodiment of an AI processor 110 is used by an AI system such as a neural network. The AI processor 110 can have one or more clusters 120 of two or more ALUs 122 managed by a scheduler 124. Each cluster has at least an ALU has one or more compute engines (CEs) as well as a cluster local memory. Note, at least one or more of the clusters of ALUs has an output that connects to its neighboring cluster. Note, (as shown above) each ALU can also be instantiated with multiple CEs via a user configurable RTL setting for the integrated circuit. Each ALU contains the RAM to feed data and weights into each CE and also store the output result from the CE. Note, a dedicated embedded processor that is embedded on a same integrated circuit as the AI processor couples to the cluster local memory in each cluster. The dedicated embedded processor is configured to perform general purpose operations and non-computational operations offloaded from the clusters of components.

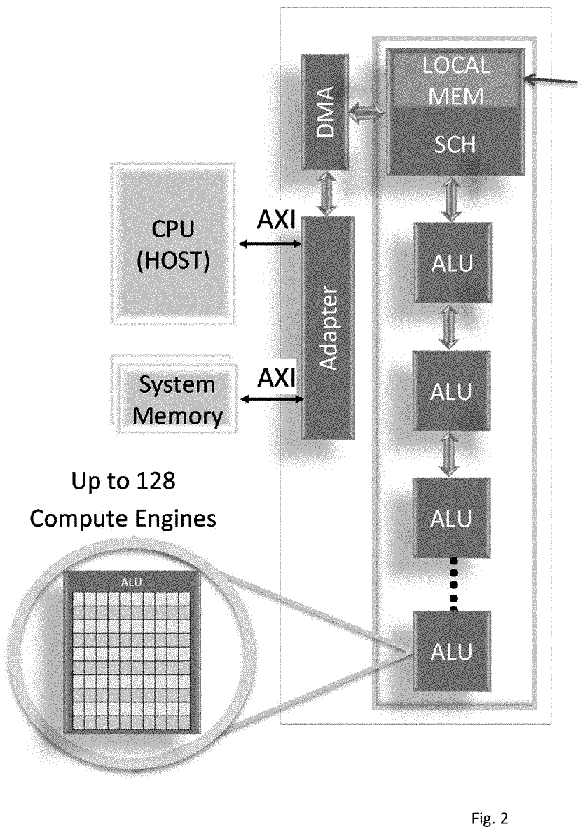

FIG. 1 is discussed in greater detail a later below. FIG. 2, in a block diagram, shows a detailed embodiment of an ALU.

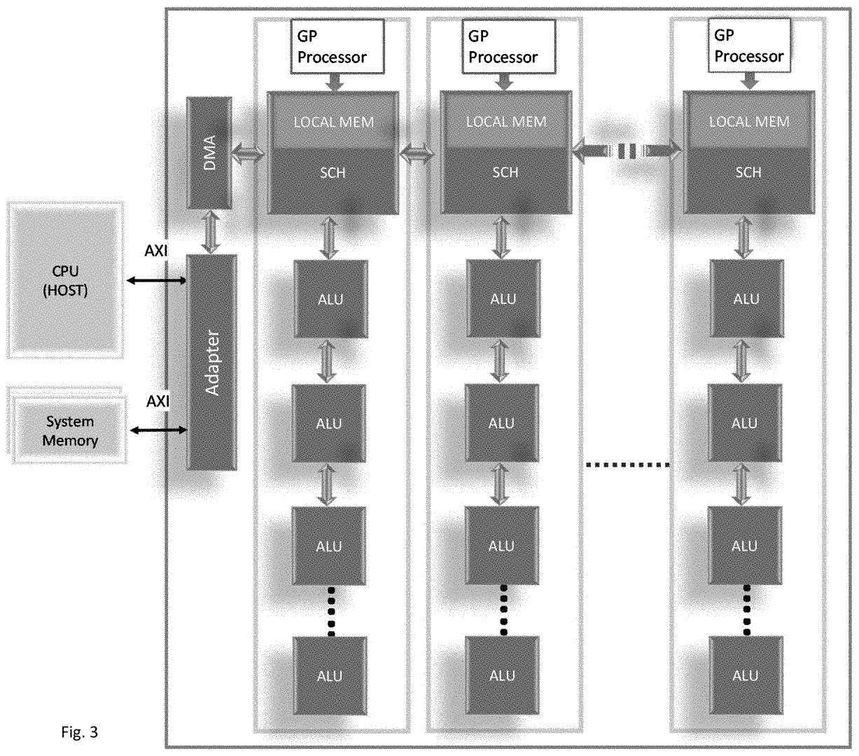

FIG. 3 illustrates, in a block diagram, one embodiment of an AI processor cooperating with a set of dedicated embedded processors, one per cluster of components. Typically, in each yellow boxed cluster, the computations and operations for AI operations occur for a neural network, such as a convolution neural network (CNN), and the different layers making up a CNN. In between the layers of the CNN, non-matrix type operation sometimes needs to be performed, for example, floating point operations and stuff like that. In addition, preprocessing and post-processing operations on the AI data often occurs, which involves other operations than essentially making calculations. The embedded processor capable of general-purpose operations integrated into the scalable architecture for neural networks and its clusters, can assist with these additional operations.

In some prior techniques, these non-computational operations are normally passed out outside of the scalable architecture for neural networks to another component such as a CPU of a host device to perform. An instance of an embedded processor capable of general-purpose operations can be integrated into each cluster of compute components scheduler, ALU, cluster local memory, etc. in the scalable architecture for neural networks.

Embedded processor capable of general-purpose operations which is capable of handling new operators, on an as-desired/needed basis. The embedded processor capable of general-purpose operations can be implemented through a Central Processing Unit, a Digital Signal Processor, or other small micro controller that is tightly coupled and sitting inside the clusters and has buses to talk directly to the local memory of the cluster.

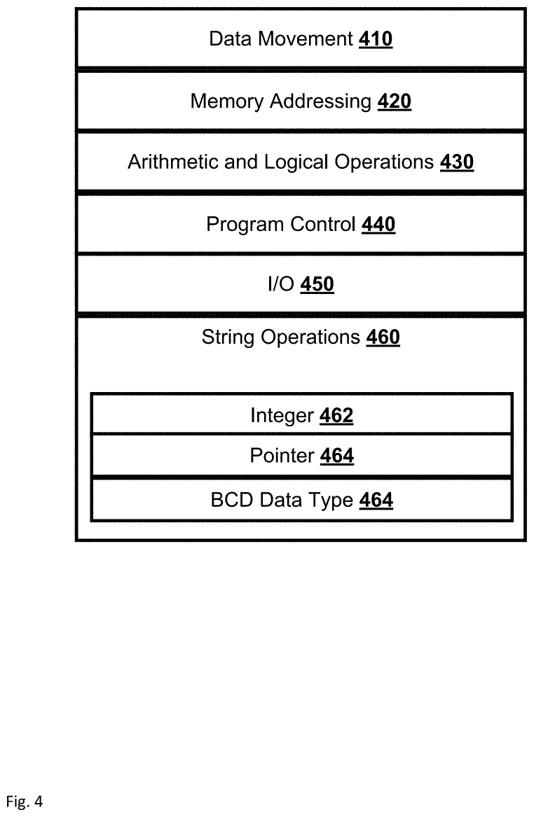

The dedicated embedded processor can store in the cluster local memory a library of a default set of general-purpose functionalities to perform. FIG. 4 illustrates, in a block diagram, one embodiment of a library of a default set of general-purposes functionalities. The general-purpose functionalities can include instructions on operations such as data movement 410, memory addressing 420, arithmetic and logical operations 430, program flow control 440, input/output 450, and string operations 460 on integer 462, pointer 464, binary code decimal (BCD) data types 466, and others. The dedicated embedded processor can reference the stored functionality when requested by cluster.

In addition, the cluster local memory can supplement the library with a user supplied functionality. The customer would define the possible operation and add the function to the library. Thus, a library of functionality exists that can be generally performed by default, and the user interface will allow users to add in customized operations and/or functionality they can add in and define.

The general-purpose functionality processor with the scalable architecture for neural networks controls AI functions and acceleration without extensive data movement compared to a possible implementation where the system sends any data to be operated out to the host general purpose CPU, which then performs those operations and then send the results back to the cluster local memory and its cluster. Thus, the general-purpose functionality processor with the scalable architecture for neural networks minimizes data transfer to and from the cluster local memory holding onto and operating on the AI data, which significantly helps with latency performance and power consumption.

The general-purpose functionality processor is integrated with the scalable architecture for neural networks including each of its clusters with its cluster local memory. A set of communication buses exist between the processor capable of general-purpose operations and the cluster local memory. A set of communication buses exist between the processor capable of general-purpose operations and the scheduler. Example communications can include interrupts. We can send an interrupt onto the general-purpose CPU for to start processing. The cluster performs its normal computations on the AI data and then can send an interrupt with the data structure to start the general-purpose functionality processor to perform the general-purpose operation. After the results of the general-purpose operation on the data stored in the cluster local memory is performed, then the results are stored in the reserved area in the cluster local memory. The scheduler at the cluster then receives the interrupt back from the from the general-purpose functionality processor.

The embedded general purpose functionality processor is different than the host CPU as it is not the master of the system. The embedded general purpose functionality processor generally remains in a sleep state until it receives an interrupt from the scheduler and/or cluster to perform an operation. The embedded general purpose functionality processor seamlessly runs general purpose computer operations integrated and alongside AI exploration operations without additional data movement from the cluster local memory.

The ASIC design could be future proofed to prevent unnecessary limitations. The dedicated embedded processor would have minimal area, perhaps no more than 0.028 mm² maximum. The dedicated embedded processor would have minimal power usage, with 18.5 μW/MHz as an upper bound. One possible candidate for a dedicated embedded general-purpose processor is the ARM™Cortex-M7*.

A benefit of using an embedded general-purpose processor in the AI core, in terms of system performance, is 1) less memory access needed with use pointers, 2) lower power consumption because of no need to transfer the data across an external bus to the host CPU and transfer the original data and or resultant data back to the AI processing core, 3) lower latency because no transferring of data, and 4) no scalability issue for larger Neural Networks. Downsides of using a host CPU located off chip from the AI processing core is concerns about 1) more memory access, 2) higher power consumption because of the need to transfer the data across an external bus to the host CPU and transfer the original data and or resultant data back to the AI processing core, 3) higher latency to factor in the transferring of data, and 4) scalability issue for larger Neural Networks.

Each cluster local memory is physically connected and located within a cluster improving both latency access via local buses, and power consumption as no need to move the data to another memory or cache to operate on the data for the AI operations. Each cluster can work off the data in its corresponding cluster local memory, which keeps the data in the cluster local memory; and thus, eliminates data moving operations and other operations.

Referring to FIG. 1, the multiple ALUs are each configured to have one or more computing engines to perform the computations for the AI system. A set of schedulers are each configured to have a local scheduler memory. Note, at least one or more of the clusters of ALUs has an output that connects to its neighboring cluster. Note, an amount of instances of the cluster of components is scalable via a user supplied Register Transfer Language (RTL) parameter supplied by a creator the Artificial Intelligence (AI) processor. The instances of the clusters are scalable using register transfer language (RTL), via parameters for performance and power including at least a number of ALUs in a cluster, a number of clusters created in an architecture of the integrated circuit, a cluster local memory size per cluster, etc. A cluster of ALUs and cluster local memory can further include a node ring running between the clusters and a broadcast bus. A compiler 130 can cooperate with the scheduler so that the system fetches the data via an advanced extensible interface (AXI) from the external memory to the processor chip (e.g., a double data rate (DDR) synchronous dynamic random access memory (SDRAM)) merely a single time per calculation session and that dramatically reduces the amount of power consumption. In an embodiment, the compiler can have multiple sub-modules. One sub-module can handle hardware instantiation to create the hardware on the chip that becomes the AI processor 110. A second submodule can act as a memory manager 132. A third sub module can use and supply a descriptor/instruction set used for different AI operations carried out by the hardware making up the AI processor 110. The memory manager 132 directs and communicates with the cluster of components to evenly divide a computation for a calculation session across the two of more clusters of components. The data fetched from the external memory/main memory DDR is sent to the cluster local memory in the scheduler a single time per calculation session. The clusters can be instantiated in parallel with each other. The cluster local memory (embedded Flash memory and/or random access memory (RAM) can store the information associated with the AI model. Note, (as shown above) each ALU can also be instantiated with multiple CEs via a user configurable RTL setting for the integrated circuit. Each ALU contains the RAM to feed data and weights into each CE and also store the output result from the CE.

The two or more clusters of components connect to a broadcast bus for the memory manager 132 to broadcast a same instruction to the two or more clusters of components at a same time to evenly divide a computation across the two of more clusters of components so that each cluster of components performs a same computation but on a different portion of data from an AI system using the AI processor 110. The memory manager 132 is configured to have a user selectable threshold for a size/amount of data from an AI system using the AI processor 110 that is compared to a size/amount of weights from the AI system using the AI processor 110. The user selectable threshold is configured to change the memory manager 132 from moving the data from the AI system a single time into the local memory in the cluster and broadcasting weights over a broadcast bus to the two or more clusters of components over to moving the weights from the AI system a single time into the local memory in the cluster and broadcasting the data from the AI system over the broadcast bus to the two or more clusters of components. At this point, the memory manager 132 will switch the AI processor 110 from Frame sub-layering across clusters over to Channel sub-layering across clusters. The memory manager 132 fetches data from an external memory from the AI processor 110 across the local memories of each corresponding cluster of components a single time per calculation session when a size of weights from the AI system using the AI processor 110 is small compared to a size of data from the AI system using the AI processor 110. The memory manager 132 is further configured to fetch the weights of the AI system from the external memory from the AI processor 110 across the local memories of each corresponding cluster of components a single time per calculation session when the size of weights from the AI system using the AI processor 110 is larger than the size of the data from the AI system using the AI processor 110.

Thus, the memory manager 132 controls a node ring connected between the multiple clusters of components and fetches data from an external memory to the local scheduler memory in a single time per calculation session. The memory manager 132 is configured to 1) when a data size of a data set from an AI-based processing model layer using the AI processor 110 is larger than a weight size, the memory manager 132 slices the data set into data set chunks evenly spread across a cluster of components, broadcasts channel instructions from the AI-based processing model layer to every cluster of components, and processes the data set chunk in the cluster of components according to the channel instructions of the AI-based processing model layer; and 2) when the data size of the data set is smaller than a weight size of the AI-based processing model layer, the memory manager 132 slices the AI-based processing model layer into channel chunks, assigns a channel chunk to a channel cluster, broadcasts the data set to every cluster, and processes the data set chunk according to channel instructions of the channel chunk.

A compiler for the AI processor 110 uses a descriptor/instruction set with specific instructions crafted to efficiently handle various operations for neural networks. For example, the compiler for the AI processor 110 uses a descriptor/instruction set with specific instructions crafted to efficiently handle various operations, addressing modes, data types, ability to address memory locations, etc., for neural networks. These neural networks can have sparse weights, manipulate one or more dimensional data, e.g., height, width, and channels and other dimensions such as images/frames per second. In an embodiment, these neural networks can have sparse weights, manipulate three or more dimensional data including dimensions such as images/frames per second, and other issues. The descriptor/instruction set includes categories of descriptors/instructions including, for example, Control descriptors/instructions; Data descriptors/instructions (used for both input and output); Weight descriptors/instructions; and Generic descriptors/instructions including e.g. generic descriptors for data transfer, etc. Note, a set of specialized registers in the scheduler, in the memory manager 132 of the compiler, etc. can be utilized to implement the descriptors/instructions for the AI processor 110. Note, the user can map any AI/Compute operation onto the target hardware (HW) of this AI processor 110 via the compiler. The scalable parameters for the hardware are fed into the compiler at compile time. The AI processor 110 block of IP is thus Neural Network agnostic. The compiler creates instructions depending on the specifics of the neural network being implemented to dynamically form virtual connections on the hardware, configurable in many different aspects, that was instantiated. The compiler can use a single instruction, multiple data (SIMD) instruction set to allow simultaneous parallel computations by each cluster, and each cluster performs the exact same instruction at any given moment just with different data.

Within the AI processor 110, the scheduler is responsible for sending data to each of the multiple ALUs connected to it via the broadcast bus for parallel processing. The scheduler feeds descriptors/instructions tailored to, for example, N-dimensional inputs (e.g., 3D objects) and weights for neural networks to these multiple parallel ALU compute units. The descriptors/instructions are utilized with the compiler and a memory manager 132 direct memory access (DMA) engine that inherently handles, for example, at least three-dimensional data and how to efficiently work with neural networks that have, for example, sparse weights that are either zero or are not important for the network or AI operation. The scheduler is responsible for driving and receiving data from all of the ALUs in the cluster. The scheduler can make use of signaling wires to each ALU to communicate when to start a calculation session and then receive notice back when a resultant output has been produced by the ALU from the calculation session.

An aspect architecturally and software-control wise is that scheduler can have multiple clusters, which are all working at that same time/working simultaneously and sharing the data, across their local memories, that comes from the external memory (e.g., DDR). The instantiated architecture and the compiler cooperate to slice and dice an AI network (e.g., neural network) being implemented, into much smaller sections. The data read from the external memory (e.g., DDR) to the AI processor chip/internet protocol (IP) block is sent to the cluster local memory (local RAM as opposed to a cache) in the scheduler a single time. Thus, the data, the model of which can be pretty large most of the time, is being fetched from the DDR into the cluster local memory RAM merely once. This allows the DDR, which accounts for a lot of power consumption in a device, can now stay in a sleep state 90% of the time when the data merely needs to be fetched once per calculation session. This component reduces the amount of data movement. Each cluster's local memory will store its portion of the entire amount of data being sent from the DDR. The local memories in each of the clusters in the scheduler generally will receive an equal portion of the entire data from the DDR to store and work within that particular cluster local memory.

In an embodiment, the input data from the DDR is divided by the software equally into the respective cluster local memory in all of the clusters.

### Data Structure Created by Software

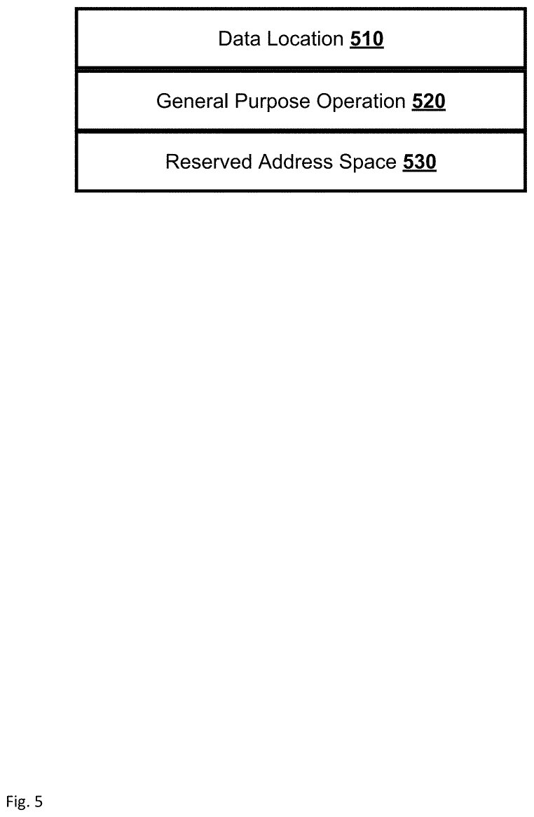

The cluster can use a data structure is created by the software to convey 1) the location of the data and/or other information to be operated upon, 2) identifying the function/general purpose operations to be performed, and 3) identifying the reserved address space in the cluster local memory to place the results. FIG. 5 illustrates, in a block diagram, one embodiment of an offload data structure. The offload data structure includes at least data for processing 510, a general-purpose operation for the dedicated embedded processor 520, and a reserved address space in the cluster local memory for storing the output 530. Many of these are facilitated via use of software data pointers.

The software program can 1) pre-allocate/reserve a set amount of memory space in the cluster local memory, say for example, 1024 Bytes, to write the data results from the operation into the cluster local memory and/or 2) alternatively put the results from the operation into the cluster local memory, note the address space occupied by the resultant data, and then use a data pointer of what is the memory address space location that is storing the result.

Note, use of the cluster local memory also eliminates a large number of memory management issues needed to use a memory sitting outside of the local cluster.

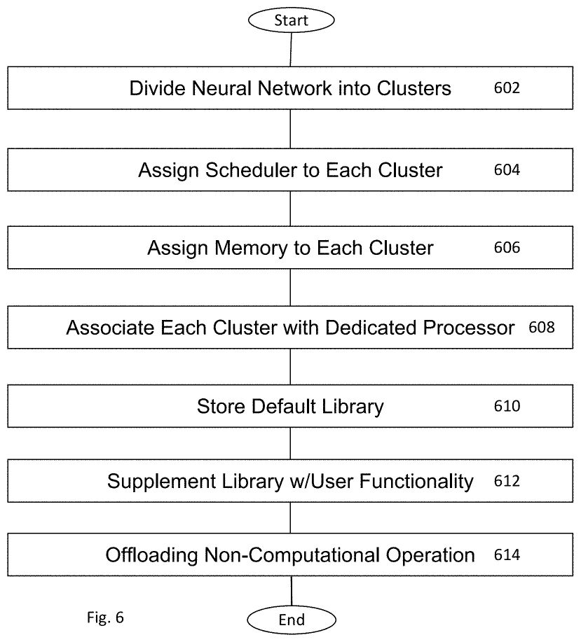

FIG. 6 illustrates, in a flowchart, one embodiment of a method for processing a data set with an artificial intelligence integrated circuit using embedded processors. An AI integrated circuit can divide a neural network of multiple arithmetic logic units each having one or more computing engines and a local arithmetic memory into multiple clusters (Block 602). The AI integrated circuit can assign a scheduler to each cluster (Block 604). The AI integrated circuit can assign a cluster local memory to each cluster (Block 606). The AI integrated circuit can associate each cluster with a dedicated processor capable of performing general purpose operations and embedded on the integrated circuit (Block 608). The AI integrated circuit can store in the cluster local memory a library of a default set of general-purpose functionalities to be performed by the embedded dedicated processor (Block 610). The AI integrated circuit can supplement the library with a user supplied functionality (Block 612). The AI integrated circuit can offload a non-computational operation for the cluster to the embedded dedicated processor (Block 614).

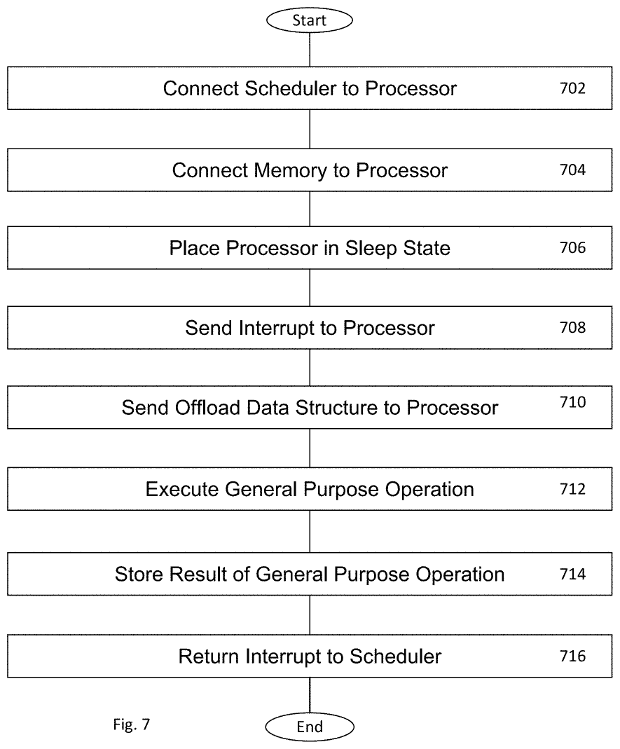

FIG. 7 illustrates, in a flowchart, one embodiment of a method for offloading a general-purpose operation to a dedicated embedded processor. An AI integrated circuit can connect the scheduler of each cluster with the dedicated embedded processor of each cluster via a scheduler communication bus (Block 702). The AI integrated circuit can connect the cluster local memory of each cluster with the dedicated embedded processor of each cluster via a memory communication bus (Block 704). The scheduler can place the dedicated embedded processor in a sleep state when not in use (Block 706). The scheduler can send an interrupt to the dedicated embedded processor via a communication bus when a general-purpose operation is to be executed by the dedicated embedded processor (Block 708). The scheduler can send an offload data structure to the dedicated embedded processor via a communication bus identifying a general-purpose operation to be executed by the dedicated embedded processor (Block 710). The dedicated embedded processor executes the general-purpose operation on the input data (Block 712). The dedicated embedded processor can store a result of the general-purpose operation in the cluster local memory (Block 714). The dedicated embedded processor can return the interrupt to the scheduler from the dedicated embedded processor via the communication bus when the general-purpose operation has been completed (Block 716).

### Electronic Design Automation

FIG. 11 illustrates a flow diagram of an embodiment of an example of a process for generating a device, such as an Intellectual Property block of functionality for an integrated circuit with the features discussed herein, in accordance with the systems and methods described herein. The example process for generating a device with designs of the integrated circuit may utilize an electronic circuit design generator, such as a Chip compiler, to form part of an Electronic Design Automation (EDA) tool set. Hardware logic, coded software, and a combination of both may be used to implement the following design process steps using an embodiment of the EDA tool set. The EDA tool set may be a single tool or a compilation of two or more discrete tools. The information representing the apparatuses and/or methods for the circuitry discussed herein may be contained in an Instance such as in a cell library, soft instructions in an electronic circuit design generator, or a similar machine-readable storage medium storing this information. The information representing the apparatuses and/or methods stored on the machine-readable storage medium may be used in the process of creating the apparatuses, or model representations of the apparatuses such as simulations and lithographic masks, and/or methods described herein.

Additionally, an EDA Development tool for the Intellectual Property block of functionality for an integrated circuit with the features discussed herein can produce key deliverables, for example, an IEEE-1801 UPF output file, that streamlines the integration of the IP into the customer design while ensuring both control protocol and electrical consistency and correctness throughout the implementation flow. Overall, the EDA process is going to have at least a couple steps—a first step incorporating the design of the concepts herein, a second step of simulation of the design of the concepts herein, a third step of analysis and verification, and then a fourth step of manufacturing preparation.

Aspects of the above design may be part of a software library containing a set of designs for components making up the integrated circuit and its associated parts. The library cells are developed in accordance with industry standards. The library of files containing design elements may be a stand-alone program by itself as well as part of the EDA tool set.

The EDA tool set may be used for making a highly configurable, scalable AI processor that integrally manages input and output data, control, debug and test flows, as well as other functions. In an embodiment, an example EDA tool set may comprise the following: a graphic user interface; a common set of processing elements; and a library of files containing design elements such as circuits, control logic, and cell arrays that define the EDA tool set. The EDA tool set may be one or more software programs comprised of multiple algorithms and designs for the purpose of generating a circuit design, testing the design, and/or placing the layout of the design in a space available on a target chip. The EDA tool set may include object code in a set of executable software programs. The set of application-specific algorithms and interfaces of the EDA tool set may be used by system integrated circuit (IC) integrators to rapidly create an individual IP core/block or an entire System of IP cores/blocks for a specific application. The EDA tool set provides timing diagrams, power and area aspects of each component, and simulates with models coded to represent the components in order to run actual operation and configuration simulations. The EDA tool set may generate a Netlist and a layout targeted to fit in the space available on a target chip. The EDA tool set may also store the data representing the Intellectual Property block of functionality for an integrated circuit corresponding to the features discussed herein on a machine-readable storage medium. The machine-readable medium may have data and instructions stored thereon, which, when executed by a machine, cause the machine to generate a representation of the physical components described above. This machine-readable medium stores an EDA tool set used in a chip design process, and the tools have the data and instructions to generate the representation of these components to instantiate, verify, simulate, and do other functions for this design.

Generally, the EDA tool set is used in two major stages of SOC design: front-end processing and back-end programming. The EDA tool set can include one or more of a RTL generator, logic synthesis scripts, a full verification testbench, and SystemC models.

Front-end processing includes the design and architecture stages, which includes design of the SOC schematic. The front-end processing may include connecting models, configuration of the design, simulating, testing, and tuning of the design during the architectural exploration. The design is typically simulated and tested. Front-end processing traditionally includes simulation of the circuits within the SOC and verification that they should work correctly. The tested and verified components then may be stored as part of a stand-alone library or part of the IP blocks on a chip. The front-end views support documentation, simulation, debugging, and testing.

In block 1205, the EDA tool set may receive a user-supplied text file having data describing configuration parameters and a design for the Intellectual Property block of functionality for an integrated circuit corresponding to the features discussed herein. The data may include one or more configuration parameters for that IP block. The IP block description may be an overall functionality of that IP block such as an Interconnect, memory scheduler, etc. The configuration parameters for the interconnect IP block and/or power management components may include parameters as described previously.

The EDA tool set receives user-supplied implementation technology parameters such as the manufacturing process to implement component level fabrication of that IP block, an estimation of the size occupied by a cell in that technology, an operating voltage of the component level logic implemented in that technology, an average gate delay for standard cells in that technology, etc. The technology parameters describe an abstraction of the intended implementation technology. The user-supplied technology parameters may be a textual description or merely a value submitted in response to a known range of possibilities.

The EDA tool set may partition the IP block design by creating an abstract executable representation for each IP sub component making up the IP block design. The abstract executable representation models TAP characteristics for each IP sub component and mimics characteristics similar to those of the actual IP block design. A model may focus on one or more behavioral characteristics of that IP block. The EDA tool set executes models of parts or all of the IP block design. The EDA tool set summarizes and reports the results of the modeled behavioral characteristics of that IP block. The EDA tool set also may analyze an application's performance and allows the user to supply a new configuration of the IP block design or a functional description with new technology parameters. After the user is satisfied with the performance results of one of the iterations of the supplied configuration of the IP design parameters and the technology parameters run, the user may settle on the eventual IP core design with its associated technology parameters.

The EDA tool set integrates the results from the abstract executable representations with potentially additional information to generate the synthesis scripts for the IP block. The EDA tool set may supply the synthesis scripts to establish various performance and area goals for the IP block after the result of the overall performance and area estimates are presented to the user.

In an embodiment, a high-level synthesis of the design description (e.g., coded in C/C++) is converted into the register transfer level (RTL), responsible for representing circuitry via the utilization of interactions between registers.

The EDA tool set may also generate an RTL file of that IP block design for logic synthesis based on the user supplied configuration parameters and implementation technology parameters. As discussed, the RTL file may be a high-level hardware description describing electronic circuits with a collection of registers, Boolean equations, control logic such as “if-then-else” statements, and complex event sequences. The RTL design description (e.g., written in Verilog or VHDL) can be translated into a discrete netlist and/or a representation of logic gates.

In block 1210, a separate design path in a chip design is called the integration stage. The integration of the system of IP blocks may occur in parallel with the generation of the RTL file of the IP block and synthesis scripts for that IP block.

The EDA tool set may provide designs of circuits and logic gates to simulate and verify the operation of the design works correctly. The system designer codes the system of IP blocks to work together. The EDA tool set generates simulations of representations of the circuits described above that can be functionally tested, timing tested, debugged and validated. The EDA tool set simulates the system of IP block's behavior. For example, an electronic circuit simulation can use mathematical models to replicate the behavior of an actual electronic device or circuit. The simulation software allows for the modeling of circuit operation. The system designer verifies and debugs the system of IP blocks' behavior. The EDA tool set tool packages the IP core. A machine-readable storage medium may also store instructions for a test generation program to generate instructions for an external tester and the Intellectual Property block of functionality for an integrated circuit corresponding to the features discussed herein to run the test sequences for the tests described herein. One of ordinary skill in the art of electronic design automation knows that a design engineer creates and uses different representations, such as software coded models, to help generate tangible useful information and/or results. Many of these representations can be high-level (abstracted and with less details) or top-down views and can be used to help optimize an electronic design starting from the system level. In addition, a design process usually can be divided into phases and at the end of each phase, a tailor-made representation to the phase is usually generated as output and used as input by the next phase. Skilled engineers can make use of these representations and apply heuristic algorithms to improve the quality of the final results coming out of the final phase. These representations allow the electric design automation world to design circuits, test and verify circuits, derive lithographic mask(s) from Netlists of circuit and other similar useful results.

In block 1215, next, system integration may occur in the integrated circuit design process. Back-end programming generally includes programming of the physical layout of the SOC such as placing and routing, or floor planning, of the circuit elements on the chip layout, as well as the routing of all metal lines between components. The back-end files, such as a layout, physical Library Exchange Format (LEF), etc. are generated for layout and fabrication.

The generated device layout may be integrated with the rest of the layout for the chip. A logic synthesis tool receives synthesis scripts for the IP core and the RTL design file of the IP cores. The logic synthesis tool also receives characteristics of logic gates used in the design from a cell library. RTL code may be generated to instantiate the SOC containing the system of IP blocks. The system of IP blocks with the fixed RTL and synthesis scripts may be simulated and verified. Synthesizing of the design with RTL may occur. The logic synthesis tool synthesizes the RTL design to create a gate level Netlist circuit design (i.e., a description of the individual transistors and logic gates making up all of the IP sub component blocks). The design may be outputted into a Netlist of one or more hardware design languages (HDL) such as Verilog, VHDL (Very-High-Speed Integrated Circuit Hardware Description Language) or SPICE (Simulation Program for Integrated Circuit Emphasis). A Netlist can also describe the connectivity of an electronic design such as the components included in the design, the attributes of each component and the interconnectivity amongst the components. The EDA tool set facilitates floor planning of components including adding of constraints for component placement in the space available on the chip such as XY coordinates on the chip, and routes metal connections for those components. The EDA tool set provides the information for lithographic masks to be generated from this representation of the IP core to transfer the circuit design onto a chip during manufacture, or other similar useful derivations of the circuits described above. Accordingly, back-end programming may further include the physical verification of the layout to verify that it is physically manufacturable and the resulting SOC will not have any function-preventing physical defects.

In block 1220, a fabrication facility may fabricate one or more chips with the signal generation circuit utilizing the lithographic masks generated from the EDA tool set's circuit design and layout. Mask data preparation or MDP can occur for the eventual generation of actual lithography photomasks, utilized to physically manufacture the chip. Fabrication facilities may use a standard CMOS logic process having minimum line widths such as 1.0 um, 0.50 um, 0.35 um, 0.25 um, 0.18 um, 0.13 um, 0.10 um, 90 nm, 65 nm or less, to fabricate the chips. The size of the CMOS logic process employed typically defines the smallest minimum lithographic dimension that can be fabricated on the chip using the lithographic masks, which in turn, determines minimum component size. According to one embodiment, light including X-rays and extreme ultraviolet radiation may pass through these lithographic masks onto the chip to transfer the circuit design and layout for the test circuit onto the chip itself.

The EDA tool set may have configuration dialog plug-ins for the graphical user interface. The EDA tool set may have an RTL generator plug-in for the SocComp. The EDA tool set may have a SystemC generator plug-in for the SocComp. The EDA tool set may perform unit-level verification on components that can be included in RTL simulation. The EDA tool set may have a test validation testbench generator. The EDA tool set may have a dis-assembler for virtual and hardware debug port trace files. The EDA tool set may be compliant with open core protocol standards. The EDA tool set may have Transactor models, Bundle protocol checkers, OCP to display socket activity, OCPPerf2 to analyze the performance of a bundle, as well as other similar programs.

As discussed, an EDA tool set may be implemented in software as a set of data and instructions, such as an instance in a software library callable to other programs or an EDA tool set consisting of an executable program with the software cell library in one program, stored on a machine-readable medium. A machine-readable storage medium may include any mechanism that stores information in a form readable by a machine (e.g., a computer). For example, a machine-readable medium may include, but is not limited to: read only memory (ROM); random access memory (RAM); magnetic disk storage media; optical storage media; flash memory devices; DVD's; EPROMs; EEPROMs; FLASH, magnetic or optical cards; or any other type of media suitable for storing electronic instructions. However, a machine-readable storage medium does not include transitory signals. The instructions and operations also may be practiced in distributed computing environments where the machine-readable media is stored on and/or executed by more than one computer system. In addition, the information transferred between computer systems may either be pulled or pushed across the communication media connecting the computer systems.

Computing Systems

FIG. 12 illustrates, in a block diagram, one example of a computing system. A computing system can be, wholly or partially, part of one or more of the server or client computing devices in accordance with some embodiments. The computing systems are specifically configured and adapted to carry out the processes discussed herein. Components of the computing system can include, but are not limited to, a processing unit having one or more processing cores, a system memory, and a system bus that couples various system components including the system memory to the processing unit. The system bus may be any of several types of bus structures selected from a memory bus or memory controller, a peripheral bus, and a local bus using any of a variety of bus architectures.

The computing system typically includes a variety of computing machine-readable media. Computing machine-readable media can be any available media that can be accessed by computing system and includes both volatile and nonvolatile media, and removable and non-removable media. By way of example, and not limitation, computing machine-readable media use includes storage of information, such as computer-readable instructions, data structures, other executable software or other data. Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 900. Transitory media such as wireless channels are not included in the machine-readable media. Communication media typically embody computer readable instructions, data structures, other executable software, or other transport mechanism and includes any information delivery media.

The system memory includes computer storage media in the form of volatile and/or nonvolatile memory such as read only memory (ROM) and random access memory (RAM). A basic input/output system (BIOS) containing the basic routines that help to transfer information between elements within the computing system, such as during start-up, is typically stored in ROM. RAM typically contains data and/or software that are immediately accessible to and/or presently being operated on by the processing unit. By way of example, and not limitation, the RAM can include a portion of the operating system, application programs, other executable software, and program data.

The drives and their associated computer storage media discussed above, provide storage of computer readable instructions, data structures, other executable software and other data for the computing system.

A user may enter commands and information into the computing system through input devices such as a keyboard, touchscreen, or software or hardware input buttons, a microphone, a pointing device and/or scrolling input component, such as a mouse, trackball or touch pad. The microphone can cooperate with speech recognition software. These and other input devices are often connected to the processing unit through a user input interface that is coupled to the system bus, but can be connected by other interface and bus structures, such as a parallel port, game port, or a universal serial bus (USB). A display monitor or other type of display screen device is also connected to the system bus via an interface, such as a display interface. In addition to the monitor, computing devices may also include other peripheral output devices such as speakers, a vibrator, lights, and other output devices, which may be connected through an output peripheral interface.

The computing system can operate in a networked environment using logical connections to one or more remote computers/client devices, such as a remote computing system. The logical connections can include a personal area network (“PAN”) (e.g., Bluetooth®), a local area network (“LAN”) (e.g., Wi-Fi), and a wide area network (“WAN”) (e.g., cellular network), but may also include other networks. Such networking environments are commonplace in offices, enterprise-wide computer networks, intranets and the Internet. A browser application may be resident on the computing device and stored in the memory.

It should be noted that the present design can be carried out on a computing system. However, the present design can be carried out on a server, a computing device devoted to message handling, or on a distributed system in which different portions of the present design are carried out on different parts of the distributed computing system.

Another device that may be coupled to bus is a power supply such as a DC power supply (e.g., battery) or an AC adapter circuit. As discussed above, the DC power supply may be a battery, a fuel cell, or similar DC power source that needs to be recharged on a periodic basis. A wireless communication module can employ a Wireless Application Protocol to establish a wireless communication channel. The wireless communication module can implement a wireless networking standard.

In some embodiments, software used to facilitate algorithms discussed herein can be embodied onto a non-transitory machine-readable medium. A machine-readable medium includes any mechanism that stores information in a form readable by a machine (e.g., a computer). For example, a non-transitory machine-readable medium can include read only memory (ROM); random access memory (RAM); magnetic disk storage media; optical storage media; flash memory devices; Digital Versatile Disc (DVD's), EPROMs, EEPROMs, FLASH memory, magnetic or optical cards, or any type of media suitable for storing electronic instructions.

Note, an application described herein includes but is not limited to software applications, mobile apps, and programs that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as C, C++, or other similar languages. Also, an algorithm can be implemented with lines of code in software, configured logic gates in software, or a combination of both. In an embodiment, the logic consists of electronic circuits that follow the rules of Boolean Logic, software that contain patterns of instructions, or any combination of both. A module can be implemented in electronic hardware, software instruction cooperating with one or more memories for storage and one of more processors for execution, and a combination of electronic hardware circuitry cooperating with software.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

Many functions performed by electronic hardware components can be duplicated by software emulation. Thus, a software program written to accomplish those same functions can emulate the functionality of the hardware components in input-output circuitry.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

What is claimed is:

1. A method for performing Artificial Intelligence (AI) operations on an integrated circuit, comprising:
dividing an AI computation of a calculation session for an AI system across multiple arithmetic logic units each having one or more computing engines and a local arithmetic memory;
storing data for the computation in the local arithmetic memory;
allowing a dedicated processor capable of performing general purpose operations and embedded on the integrated circuit to have access to the stored data for the computation in the local arithmetic memory; and
performing a non-computational operation for the AI system with the embedded dedicated processor.

2. The method for executing neural network computations on an AI integrated circuit of claim 1, further comprising:
storing in a cluster local memory a library of a default set of general-purpose functionalities to be performed by the embedded dedicated processor.

3. The method for executing neural network computations on an AI integrated circuit of claim 2, further comprising:
supplementing the library with a user supplied functionality.

4. The method for executing neural network computations on an AI integrated circuit of claim 1, further comprising:
using a scheduler connected to the multiple arithmetic logic units to communicate with the dedicated embedded processor via a scheduler communication bus; and
using a cluster local memory pass a general-purpose operation to the dedicated embedded processor via a memory communication bus.

5. The method for executing neural network computations on an AI integrated circuit of claim 1, further comprising:
placing the dedicated embedded processor in a sleep state when not in use.

6. The method for executing neural network computations on an AI integrated circuit of claim 1, further comprising:
sending an interrupt from the scheduler to the dedicated embedded processor via a communication bus when a general-purpose operation is to be executed by the dedicated embedded processor.

7. The method for executing neural network computations on an AI integrated circuit of claim 1, further comprising:
sending a data structure with at least data for processing and a general-purpose operation for the dedicated embedded processor to perform from the scheduler to the dedicated embedded processor via a communication bus identifying the general-purpose operation to be executed by the dedicated embedded processor.

8. The method for executing neural network computations on an AI integrated circuit of claim 7, further comprising:
storing a result of the general-purpose operation in the cluster local memory.

9. The method for executing neural network computations on an AI integrated circuit of claim 7, further comprising:
returning the interrupt to the scheduler from the dedicated embedded processor via the communication bus when the general-purpose operation has been completed.

10. A non-transitory computer readable medium comprising computer readable code operable, when executed by one or more processing apparatuses in integrated circuit to instruct a computing device to perform the method of claim 1.

11. An apparatus, comprising:
an Artificial Intelligence (AI) processor composed of two or more clusters of components, where each cluster includes two or more arithmetic logic units (ALUs) that each have one or more compute engines, a scheduler, and a cluster local memory;
a memory manager to direct and communicate with the cluster of components to evenly divide a computation for a calculation session across the two of more clusters of components; and
a dedicated embedded processor is embedded on a same integrated circuit as the AI processor and coupled to the cluster local memory in each cluster, where the dedicated embedded processor is configured to perform general purpose operations and non-computational operations offloaded from the clusters of components.

12. The apparatus of claim 11, wherein the dedicated embedded processor is at least one of a central processing unit, a digital signal processor, and a micro controller.

13. The integrated circuit of claim 11, wherein multiple instances of the dedicated embedded processor are embedded on the same integrated circuit as the AI processor and each cluster of components has its own instance of the dedicated embedded processor connected to that cluster of components.

14. The apparatus of claim 11, where at least a first cluster of the two or more clusters of components has an output that connects to its neighboring cluster.

15. The apparatus of claim 11, wherein the cluster local memory is configured to store a library of a default set of general-purpose functionalities to be performed by the embedded dedicated processor.

16. The apparatus of claim 15, wherein the cluster local memory is configured to supplement the library with a user supplied functionality.

17. The apparatus of claim 15, wherein the general-purpose functionalities are at least one of data movement, memory addressing, arithmetic and logical operations, program flow control, input/output, and string operations on integer, pointer, or binary code decimal data type.

18. The apparatus of claim 11, further comprising:
a scheduler communication bus connects the scheduler of each cluster with the dedicated embedded processor of each cluster; and
a memory communication bus connects the cluster local memory of each cluster with the dedicated embedded processor of each cluster to minimize data transfer to and from the cluster local memory.

19. The apparatus of claim 11, wherein the scheduler in a first cluster of components is configured to connect to the dedicated embedded processor via a communication bus connecting directly between the first cluster of components to the dedicated embedded processor to allow a general-purpose operation to be executed by the dedicated embedded processor on data stored in the cluster local memory.

20. The apparatus of claim 19, wherein the scheduler is configured to send a data structure that includes at least data for processing, a general-purpose operation for the dedicated embedded processor, and a reserved address space in the cluster local memory for storing the output.
